(19) United States
(12) Patent Application Publication
(10) Pub. No.: US 2025/0056379 A1
(43) Pub. Date: Feb. 13, 2025

(54) METHOD AND ELECTRONIC DEVICE TO RECOVER FROM A FORBIDDEN TRACKING AREA IDENTITY (FTAI) AFTER NO SLICES AVAILABLE IN NETWORK

(71) Applicant: MediaTek Singapore Pte. Ltd., Singapore (SG)

(72) Inventors: Puneet, Bengaluru KA (IN); Jaakko Sitomaniemi, Oulu (FI)

(21) Appl. No.: 18/675,718

(22) Filed: May 28, 2024

(30) Foreign Application Priority Data
Jun. 30, 2023 (CN) 202321044101

(51) Int. Cl. H04W 48/04; H04W 48/14; H04W 48/18; H04W 60/06

(52) U.S. Cl. CPC H04W 48/04; H04W 48/14; H04W 48/18; H04W 60/06

(57) ABSTRACT

A method to recover from a forbidden tracking area identity (FTAI) after no slices available in a network is provided. The method is applied to user equipment. The method includes the following steps. A reject cause #62 (no network slices available) in a message is received from the network. There is an allowed network slice selection assistance information (NSSAI) or configured NSSAI in the message. All single-NSSAI (S-NSSAI) in the allowed NSSAI and the configured NSSAI are rejected, and at least one S-NSSAI is rejected due to “S-NSSAI not available in a current registration area”. A suitable cell in another tracking area is sought.

### CROSS REFERENCE TO RELATED APPLICATIONS

This application claims priority of India patent application No. 202321044101, filed on Jun. 30, 2023, the entirety of which is incorporated by reference herein.

### BACKGROUND OF THE INVENTION

### Field of the Invention

The present invention relates to a recovery method, and, in particular, to a method and an electronic device to recover from a forbidden tracking area identity (FTAI) after no slices available in a network.

### Description of the Related Art

When registration is rejected for cause #62 and all the single network slice selection assistance information (S-NSSAI) in the allowed NSSAI and configured NSSAI or in the default configured NSSAI are rejected and at least one S-NSSAI is rejected due to “S-NSSAI not available in the current registration area”, the UE shall store the current tracking area identity (TAI) on the list of “5GS forbidden tracking areas for roaming”, memorize that the current TAI was stored on the list of “5GS forbidden tracking areas for roaming” for S-NSSAI is rejected due to “S-NSSAI not available” in the current registration area, and enter the state of 5GMM-DEREGISTERED.LIMITED-SERVICE.

However, there is no recovery mechanism that is defined like whether the UE should stay on the current cell for limited services, or whether the UE should perform a public land mobile network (PLMN) search procedure, or whether the UE should go for a cell selection procedure in another tracking area (TA).

### BRIEF SUMMARY OF THE INVENTION

An embodiment of the present invention provides a method to recover from a forbidden tracking area identity (FTAI) after no slices available in a network. The method is applied to user equipment (UE). The method includes the following steps. A reject cause #62 (no network slices available) in a message is received from the network. There is an allowed network slice selection assistance information (NSSAI) or configured NSSAI in the message. All single-NSSAI (S-NSSAI) in the allowed NSSAI and the configured NSSAI are rejected, and at least one S-NSSAI is rejected due to “S-NSSAI not available in a current registration area”. A suitable cell in another tracking area is sought.

The method further includes not searching for a public land mobile network (PLMN), and staying in the same tracking area identity (TAI) for a limited service.

The method further includes searching for a suitable cell in the same public land mobile network (PLMN) but belonging to a tracking area that is not in a “5GS forbidden tracking areas for roaming” list.

The method further includes the following steps. Access to a stand-alone non-Public network (SNPN) using credentials from a credentials holder, equivalent SNPNs or both, a selected entry of a “list of subscriber data” or a selected same public land mobile network (PLMN) subscription is supported. The suitable cell in the same PLMN but belonging to a tracking area which is not on a list of “5GS forbidden tracking areas for roaming” is sought.

The method further includes the following steps. A public land mobile network (PLMN) selection or a stand-alone non-Public network (SNPN) selection for 3^{rd} Generation Partnership Project (3GPP) access is performed. A network selection for non-3GPP access is performed.

According to the method described above, the message from the network is either a REGISTRATION REJECT message or a DEREGISTRATION REQUEST message.

The method further includes entering a state of 5GMM-DEREGISTERED.LIMITED-SERVICE.

An embodiment of the present invention also provides a method to recover from a forbidden tracking area identity (FTAI) after no slices available in a network. The method is applied to user equipment. The method includes the following steps. A reject cause #62 (no network slices available) in a message from the network is received. There are neither allowed network slice selection assistance information (NSSAI) for a current public land mobile network (PLMN) nor configured NSSAI for the current PLMN in the message. All single-NSSAI (S-NSSAI) in a default configured NSSAI are rejected, and at least one S-NSSAI is rejected due to “S-NSSAI not available in a current registration area”. A suitable cell in another tracking area is sought.

An embodiment of the present invention further provides an electronic device including a processor. The processor receives a reject cause #62 (no network slices available) in a message from the network. The processor has an allowed network slice selection assistance information (NSSAI) or configured NSSAI in the message. All single-NSSAI (S-NSSAI) in the allowed NSSAI and the configured NSSAI are rejected, and at least one S-NSSAI is rejected due to “S-NSSAI not available in a current registration area”. The processor searches for a suitable cell in another tracking area.

According to the electronic device described above, the processor does not search for a public land mobile network (PLMN), and stays in the same tracking area identity (TAI) for a limited service.

According to the electronic device described above, the processor searches for a suitable cell in the same public land mobile network (PLMN) but belonging to a tracking area which is not on a list of “5GS forbidden tracking areas for roaming”.

According to the electronic device described above, the processor supports access to a stand-alone non-Public network (SNPN) using credentials from a credentials holder, equivalent SNPNs or both, a selected entry of a “list of subscriber data” or a selected same public land mobile network (PLMN) subscription, and searches for a suitable cell in the same PLMN but belonging to a tracking area which is not on a list of “5GS forbidden tracking areas for roaming”.

According to the electronic device described above, the processor performs a PLMN selection or a stand-alone non-Public network (SNPN) selection for 3rd Generation Partnership Project (3GPP) access, and performs a network selection for non-3GPP access.

According to the electronic device described above, the message from the network is either a REGISTRATION REJECT message or a DEREGISTRATION REQUEST message.

According to the electronic device described above, the processor enters a state of 5GMM-DEREGISTERED.LIMITED-SERVICE.

An embodiment of the present invention further provides an electronic device including a processor. The processor receives a reject cause #62 (no network slices available) in a message from the network. The processor has neither allowed network slice selection assistance information (NSSAI) for a current public land mobile network (PLMN) nor configured NSSAI for the current PLMN in the message. All single-NSSAI (S-NSSAI) in a default configured NSSAI are rejected, and at least one S-NSSAI is rejected due to “S-NSSAI not available in a current registration area”. The processor searches for a suitable cell in another tracking area.

### BRIEF DESCRIPTION OF THE DRAWINGS

The present invention can be more fully understood by reading the subsequent detailed description and examples with references made to the accompanying drawings, wherein:

FIG. 1 shows a flow chart of a method to recover from a forbidden tracking area identity (FTAI) after no slices available in a network in accordance with some embodiments of the present invention;

FIG. 2 shows a flow chart of a method to recover from a forbidden tracking area identity (FTAI) after no slices available in a network in accordance with some embodiments of the present invention;

FIG. 3 shows a schematic diagram of a communication system 300 in accordance with some embodiments of the present invention.

### DETAILED DESCRIPTION OF THE INVENTION

In order to make the above purposes, features, and advantages of some embodiments of the present invention more comprehensible, the following is a detailed description in conjunction with the accompanying drawing.

Certain terms are used throughout the description and following claims to refer to particular components. As one skilled in the art will understand, electronic equipment manufacturers may refer to a component by different names. This document does not intend to distinguish between components that differ in name but not function. It is understood that the words “comprise”, “have” and “include” are used in an open-ended fashion, and thus should be interpreted to mean “include, but not limited to . . . ”. Thus, when the terms “comprise”, “have” or “include” used in the present invention are used to indicate the existence of specific technical features, values, method steps, operations, units or components. However, it does not exclude the possibility that more technical features, numerical values, method steps, work processes, units, components, or any combination of the above can be added.

The directional terms used throughout the description and following claims, such as: “on”, “up”, “above”, “down”, “below”, “front”, “rear”, “back”, “left”, “right”, etc., are only directions referring to the drawings. Therefore, the directional terms are used for explaining and not used for limiting the present invention. Regarding the drawings, the drawings show the general characteristics of methods, structures, or materials used in specific embodiments. However, the drawings should not be construed as defining or limiting the scope or properties encompassed by these embodiments. For example, for clarity, the relative size, thickness, and position of each layer, each area, or each structure may be reduced or enlarged.

When the corresponding component such as layer or area is referred to as being “on another component”, it may be directly on this other component, or other components may exist between them. On the other hand, when the component is referred to as being “directly on another component (or the variant thereof)”, there is no component between them. Furthermore, when the corresponding component is referred to as being “on another component”, the corresponding component and the other component have a disposition relationship along a top-view/vertical direction, the corresponding component may be below or above the other component, and the disposition relationship along the top-view/vertical direction is determined by the orientation of the device.

It should be understood that when a component or layer is referred to as being “connected to” another component or layer, it can be directly connected to this other component or layer, or intervening components or layers may be present. In contrast, when a component is referred to as being “directly connected to” another component or layer, there are no intervening components or layers present.

The electrical connection or coupling described in this disclosure may refer to direct connection or indirect connection. In the case of direct connection, the endpoints of the components on the two circuits are directly connected or connected to each other by a conductor line segment, while in the case of indirect connection, there are switches, diodes, capacitors, inductors, resistors, other suitable components, or a combination of the above components between the endpoints of the components on the two circuits, but the intermediate component is not limited thereto.

The words “first”, “second”, “third”, “fourth”, “fifth”, and “sixth” are used to describe components. They are not used to indicate the priority order of or advance relationship, but only to distinguish components with the same name.

It should be noted that the technical features in different embodiments described in the following can be replaced, recombined, or mixed with one another to constitute another embodiment without depart in from the spirit of the present invention.

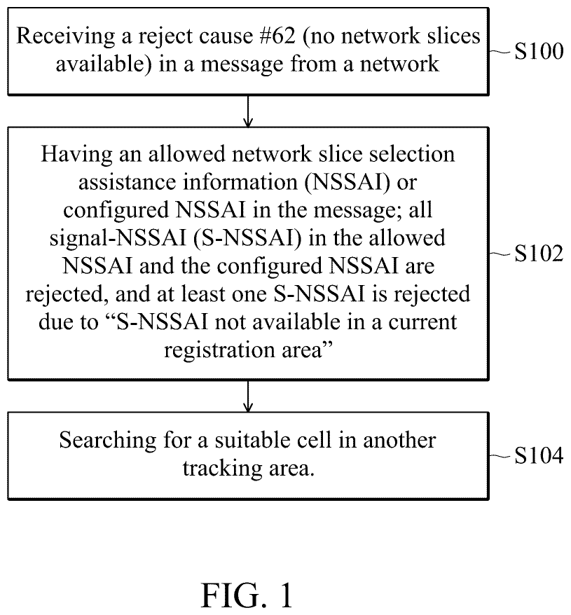

FIG. 1 shows a flow chart of a method to recover from a forbidden tracking area identity (FTAI) after no slices available in a network in accordance with some embodiments of the present invention. The method is applied to user equipment (UE). In some embodiments, the UE may be a laptop, a tablet, or a smart phone, but the present invention is not limited thereto. In some embodiments, the UE is included in a communication system, which further includes a base station. The UE is able to access a network through the base station. The UE is connected with the base station by Radio Resource Control (RRC) signaling, but the present invention is not limited thereto. In some embodiments, the base station may be a gNB, but the present invention is not limited thereto.

As shown in FIG. 1, the method includes the following steps. A reject cause #62 (no network slices available) in a message from the network is received (step S100). There is an allowed network slice selection assistance information (NSSAI) or configured NSSAI in the message. All single-NSSAI (S-NSSAI) in the allowed NSSAI and the configured NSSAI are rejected, and at least one S-NSSAI is rejected due to “S-NSSAI not available in a current registration area” (step S102). A suitable cell in another tracking area is sought (step S104). In some embodiments, in step S100, the registration is rejected with clause #62 (that is, no network slices available) in the message. In some embodiments, the message in step S100 is either a REGISTRATION REJECT message or a DEREGISTRATION REQUEST message received from the network through the base station.

Afterwards, in step S102, the UE has an allowed network slice selection assistance information (NSSAI) or configured NSSAI in the message. All single-NSSAI (S-NSSAI) in the allowed NSSAI and the configured NSSAI are rejected, and at least one S-NSSAI is rejected due to “S-NSSAI not available in a current registration area”. Next, in step S104, the UE searches for a suitable cell in another tracking area. In some embodiments, the UE searches for a suitable cell in another tracking area according to 3GPP TS 38.304 [28] or 3GPP TS 36.304 [25C]. In some embodiments, for the UE not operating in a stand-alone non-Public network (SNPN) access mode, a cell is considered as suitable if the following conditions are fulfilled. First, the cell is part of either the selected public land mobile network (PLMN) or the registered PLMN or PLMN of the equivalent PLMN list. For that PLMN, either the PLMN-ID of that PLMN is broadcast by the cell with no associated Closed Access Group IDs (CAG-IDs) and CAG-only indication in the UE for that PLMN (TS 23.501 [10]) is absent or false, or allowed CAG list in the UE for that PLMN (TS 23.501 [10]) includes a CAG-ID broadcast by the cell for that PLMN. Second, the cell selection criteria are fulfilled. In some embodiments, the cell is considered as suitable according to the latest information provided by non-access stratum (NAS). For example, the cell is not barred. The cell is part of at least one tracking area (TA) that is not part of a list of “forbidden tracking areas for roaming” (TS 22.011 [8]).

In some embodiments, for the UE operating in SNPN access mode, a cell is considered as suitable if the following conditions are fulfilled. First, the cell is part of either the selected SNPN or the registered SNPN of the UE. Second, the cell selection criteria are fulfilled. In some embodiments, the cell is considered as suitable according to the latest information provided by NAS. For example, the cell is not barred. The cell is part of at least one TA that is not part of the list of “forbidden tracking areas for roaming” which belongs to either the selected SNPN or the registered SNPN of the UE.

In some embodiments, after steps S100 and S102 are performed, the UE does not search for a public land mobile network (PLMN). The UE stays in the same tracking area identity (TAI) for a limited service. In some embodiments, the UE enters a state of 5GMM-DEREGISTERED.LIMITED-SERVICE. In some embodiments, after steps S100 and S102 are performed, the UE searches for a suitable cell in the same PLMN but belonging to a tracking area which is not on the list of “5GS forbidden tracking areas for roaming”.

In some embodiments, after steps S100 and S102 are performed, if the UE supports access to an SNPN using credentials from a credentials holder, equivalent SNPNs or both, a selected entry of a “list of subscriber data” or a selected same public land mobile network (PLMN) subscription, the UE searches for a suitable cell in the same PLMN but belonging to a tracking area which is not on the list of “5GS forbidden tracking areas for roaming”.

In some embodiments, after steps S100 and S102 are performed, the UE performs a PLMN selection or a SNPN selection for 3rd Generation Partnership Project (3GPP) access. The UE performs a network selection for non-3GPP access. In some embodiments, the UE performs the PLMN selection or the SNPN selection for 3GPP access according to 3GPP TS 23.122. The UE performs the network selection for non-3GPP access according to 3GPP TS 24.502.

For example, for UE NAS in RRC_IDLE state and RRC_INACTIVE state, the PLMN selection and the SNPN selection can be done by the following actions. For a UE not operating in SNPN access mode, the UE maintains a list of PLMNs in priority order according to TS 23.122 [9]. The UE selects a PLMN using automatic or manual mode as specified in TS 23.122 [9] and requests UE access stratum (AS) to select a cell belonging to this PLMN. For each PLMN, associated radio access technology (RAT) may be set. The UE evaluates reports of available PLMNs and any associated CAG-IDs from AS for PLMN selection. The UE maintains a list of equivalent PLMN identities. The UE maintains a list of “PLMNs not allowed to operate at the present UE location”. The UE maintains applicable disaster roaming information for available PLMNs including potential disaster PLMNs for available PLMNs. To support manual CAG selection, the UE provides request to search for available CAGs and evaluates reports of available CAGs from AS for CAG selection.

For a UE operating in SNPN access mode, the UE maintains a list of SNPNs according to TS 23.122 [9]. The UE selects an SNPN using automatic or manual mode as specified in TS 23.122 [9] and requests AS to select a cell belonging to this SNPN. The UE evaluates reports of available SNPNs from AS for SNPN selection.

In some embodiments, for UE AS in RRC_IDLE state and RRC_INACTIVE state, the PLMN selection and the SNPN selection can be done by the following actions. For a UE not operating in SNPN access mode, the UE searches for available PLMNs. If associated RATs are set for the PLMN, the UE searches in these RATs and other RATs for that PLMN specified in TS 23.122 [9]. For a UE operating in SNPN access mode, the UE searches for available SNPNs only consider New Radio (NR) cells. The UE performs measurements to support PLMN/SNPN selection. The UE synchronizes to a broadcast channel to identify found PLMNs/SNPNs. The UE reports available PLMNs and any associated CAG-IDs with associated RATs to NAS on request from NAS or autonomously. The UE reports applicable disaster roaming information for available PLMNs autonomously including potential disaster PLMNs.

For a UE operating in SNPN access mode, the UE reports available SNPNs to NAS autonomously. The UE reports information related to SNPN access with subscription of a different credentials holders, indicator whether onboarding is enabled, and the list of supported GINs to NAS autonomously, as specified in TS 38.331 [3]. To support manual CAG selection, the UE searches for cells broadcasting a CAG-ID. The UE reports CAG-ID(s) of found cell(s) broadcasting a CAG-ID together with the associated manual CAG selection allowed indicator, Human-Readable Network Name (HRNN) and PLMN to NAS. On selection of a CAG by NAS, the UE selects any acceptable or suitable cell belonging the selected CAG and gives an indication to NAS that access is possible for the registration procedure. To support manual SNPN selection, the UE reports available SNPNs together with associated HRNNs (if available) to NAS on request from NAS.

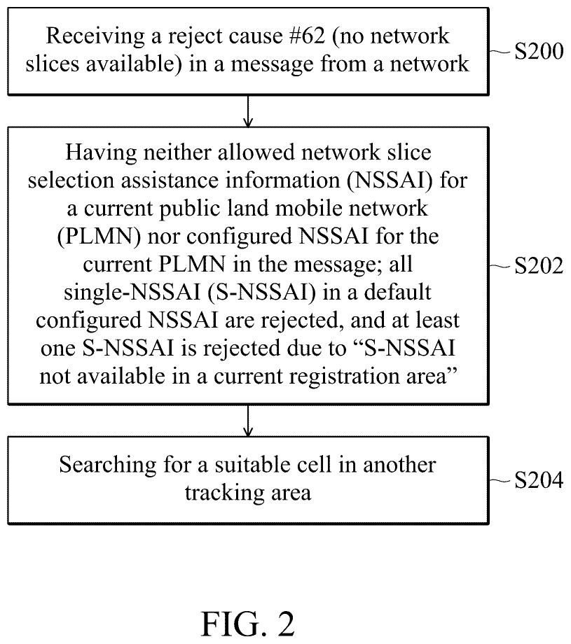

FIG. 2 shows a flow chart of a method to recover from a forbidden tracking area identity (FTAI) after no slices available in a network in accordance with some embodiments of the present invention. The method is also applied to UE. As shown in FIG. 2, the method includes the following steps. A reject cause #62 (no network slices available) in a message from the network is received (step S200). There are neither allowed network slice selection assistance information (NSSAI) for a current public land mobile network (PLMN) nor configured NSSAI for the current PLMN in the message. All single-NSSAI (S-NSSAI) in a default configured NSSAI are rejected, and at least one S-NSSAI is rejected due to “S-NSSAI not available in a current registration area” (step S202). A suitable cell in another tracking area is sought (step S204). In some embodiments, the message in step S200 is either a REGISTRATION REJECT message or a DEREGISTRATION REQUEST message received from the network through the base station.

Afterwards, in step S202, the UE has neither allowed network slice selection assistance information (NSSAI) for a current public land mobile network (PLMN) nor configured NSSAI for the current PLMN in the message. All single-NSSAI (S-NSSAI) in a default configured NSSAI are rejected, and at least one S-NSSAI is rejected due to “S-NSSAI not available in a current registration area”. Next, in step S204, the UE searches for a suitable cell in another tracking area. In some embodiments, the UE searches for a suitable cell in another tracking area according to 3GPP TS 38.304 [28] or 3GPP TS 36.304 [25C]. In some embodiments, for the UE not operating in a stand-alone non-Public network (SNPN) access mode, a cell is considered as suitable if the following conditions are fulfilled. First, the cell is part of either the selected public land mobile network (PLMN) or the registered PLMN or PLMN of the equivalent PLMN list. For that PLMN, either the PLMN-ID of that PLMN is broadcast by the cell with no associated Closed Access Group IDs (CAG-IDs) and CAG-only indication in the UE for that PLMN (TS 23.501 [10]) is absent or false, or allowed CAG list in the UE for that PLMN (TS 23.501 [10]) includes a CAG-ID broadcast by the cell for that PLMN. Second, the cell selection criteria are fulfilled. In some embodiments, the cell is considered as suitable according to the latest information provided by non-access stratum (NAS). For example, the cell is not barred. The cell is part of at least one tracking area (TA) that is not part of a list of “forbidden tracking areas for roaming” (TS 22.011 [8]).

In some embodiments, for the UE operating in SNPN access mode, a cell is considered as suitable if the following conditions are fulfilled. First, the cell is part of either the selected SNPN or the registered SNPN of the UE. Second, the cell selection criteria are fulfilled. In some embodiments, the cell is considered as suitable according to the latest information provided by NAS. For example, the cell is not barred. The cell is part of at least one TA that is not part of the list of “forbidden tracking areas for roaming” which belongs to either the selected SNPN or the registered SNPN of the UE.

In some embodiments, after steps S200 and S202 are performed, the UE does not search for a public land mobile network (PLMN). The UE stays in the same tracking area identity (TAI) for a limited service. In some embodiments, the UE enters a state of 5GMM-DEREGISTERED.LIMITED-SERVICE. In some embodiments, after steps S200 and S202 are performed, the UE searches for a suitable cell in the same PLMN but belonging to a tracking area which is not on the list of “5GS forbidden tracking areas for roaming”.

In some embodiments, after steps S200 and S202 are performed, if the UE supports access to an SNPN using credentials from a credentials holder, equivalent SNPNs or both, a selected entry of a “list of subscriber data” or a selected same public land mobile network (PLMN) subscription, the UE searches for a suitable cell in the same PLMN but belonging to a tracking area which is not on the list of “5GS forbidden tracking areas for roaming”.

In some embodiments, after steps S200 and S202 are performed, the UE performs the PLMN selection or the SNPN selection for 3GPP access. The UE performs the network selection for non-3GPP access. In some embodiments, the UE performs the PLMN selection or the SNPN selection for 3GPP access according to 3GPP TS 23.122. The UE performs the network selection for non-3GPP access according to 3GPP TS 24.502.

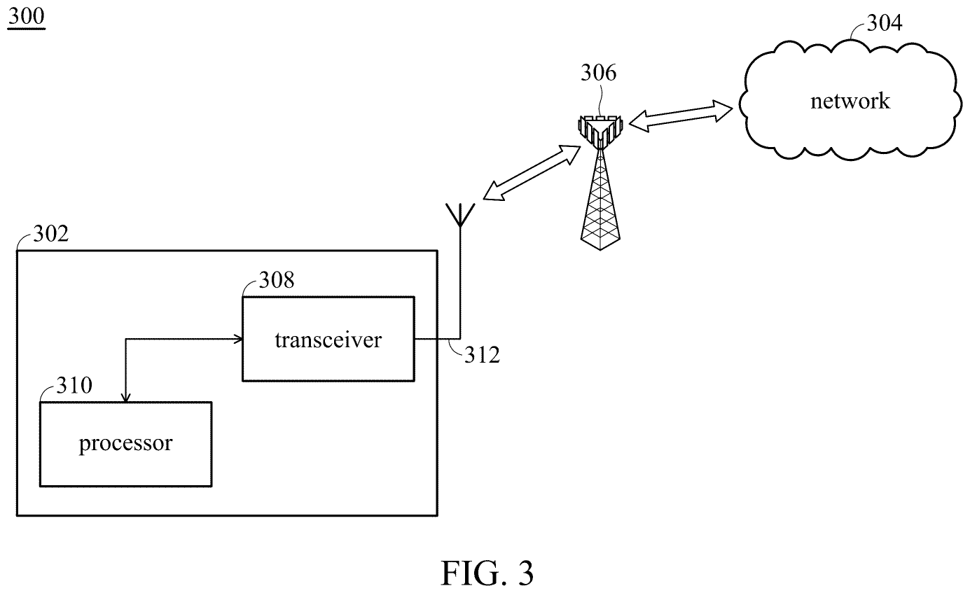

FIG. 3 shows a schematic diagram of a communication system 300 in accordance with some embodiments of the present invention. As shown in FIG. 3, the communication system 300 includes a UE 302, a network 304, and a base station 306. In some embodiments, the UE 302 may be a laptop, a tablet, or a smart phone, but the present invention is not limited thereto. In some embodiments, the UE 302 is able to access the network 304 through the base station 306. The UE 302 is connected with the base station 306 by Radio Resource Control (RRC) signaling, but the present invention is not limited thereto. In some embodiments, the base station 306 may be a gNB, but the present invention is not limited thereto.

In some embodiments, the UE 302 includes an antenna 312, a transceiver 308, and a processor 310. The transceiver 308 is electrically connected between the antenna 312 and the processor 310. The processor 310 may be a modem, but the present invention is not limited thereto. In some embodiments, the UE 302 further includes a memory (not shown) storing a plurality of codes. The processor 310 reads the codes stored in the memory to execute the steps as follows. The processor 310 receives a reject cause #62 (no network slices available) in a message from the network 304. In some embodiments, the message is either a REGISTRATION REJECT message or a DEREGISTRATION REQUEST message. The registration of the UE 302 is rejected with clause #62 (that is, no network slices available) in the message.

The processor 310 has an allowed network slice selection assistance information (NSSAI) or configured NSSAI in the message. All single-NSSAI (S-NSSAI) in the allowed NSSAI and the configured NSSAI are rejected, and at least one S-NSSAI is rejected due to “S-NSSAI not available in a current registration area”. The processor 310 then searches for a suitable cell in another tracking area. In some embodiments, the processor 310 searches for a suitable cell in another tracking area according to 3GPP TS 38.304 [28] or 3GPP TS 36.304 [25C]. In some embodiments, for the UE 302 not operating in a stand-alone non-Public network (SNPN) access mode, a cell is considered as suitable if the following conditions are fulfilled. First, the cell is part of either the selected public land mobile network (PLMN) or the registered PLMN or PLMN of the equivalent PLMN list. For that PLMN, either the PLMN-ID of that PLMN is broadcast by the cell with no associated Closed Access Group IDs (CAG-IDs) and CAG-only indication in the UE 302 for that PLMN (TS 23.501 [10]) is absent or false, or allowed CAG list in the UE for that PLMN (TS 23.501 [10]) includes a CAG-ID broadcast by the cell for that PLMN. Second, the cell selection criteria are fulfilled. In some embodiments, the cell is considered as suitable according to the latest information provided by non-access stratum (NAS). For example, the cell is not barred. The cell is part of at least one tracking area (TA) that is not part of a list of “forbidden tracking areas for roaming” (TS 22.011 [8]).

In some embodiments, for the UE 302 operating in SNPN access mode, a cell is considered as suitable if the following conditions are fulfilled. First, the cell is part of either the selected SNPN or the registered SNPN of the UE 302. Second, the cell selection criteria are fulfilled. In some embodiments, the cell is considered as suitable according to the latest information provided by NAS. For example, the cell is not barred. The cell is part of at least one TA that is not part of the list of “forbidden tracking areas for roaming” which belongs to either the selected SNPN or the registered SNPN of the UE 302.

In some embodiments, if the UE 302 has an allowed network slice selection assistance information (NSSAI) or configured NSSAI in the message, all single-NSSAI (S-NSSAI) in the allowed NSSAI and the configured NSSAI are rejected, and at least one S-NSSAI is rejected due to “S-NSSAI not available in a current registration area”, the UE 302 does not search for a public land mobile network (PLMN). The UE 302 stays in the same tracking area identity (TAI) for a limited service. In some embodiments, the UE 302 enters a state of 5GMM-DEREGISTERED.LIMITED-SERVICE. In some embodiments, if the UE 302 has an allowed network slice selection assistance information (NSSAI) or configured NSSAI in the message, all single-NSSAI (S-NSSAI) in the allowed NSSAI and the configured NSSAI are rejected, and at least one S-NSSAI is rejected due to “S-NSSAI not available in a current registration area”, the UE 302 searches for a suitable cell in the same PLMN but belonging to a tracking area which is not on the list of “5GS forbidden tracking areas for roaming”.

In some embodiments, the UE 302 has an allowed network slice selection assistance information (NSSAI) or configured NSSAI in the message. All single-NSSAI (S-NSSAI) in the allowed NSSAI and the configured NSSAI are rejected, and at least one S-NSSAI is rejected due to “S-NSSAI not available in a current registration area”. If the UE 302 supports access to an SNPN using credentials from a credentials holder, equivalent SNPNs or both, a selected entry of a “list of subscriber data” or a selected same public land mobile network (PLMN) subscription, the UE 302 searches for a suitable cell in the same PLMN but belonging to a tracking area which is not on the list of “5GS forbidden tracking areas for roaming”.

In some embodiments, if the UE 302 has an allowed network slice selection assistance information (NSSAI) or configured NSSAI in the message, all single-NSSAI (S-NSSAI) in the allowed NSSAI and the configured NSSAI are rejected, and at least one S-NSSAI is rejected due to “S-NSSAI not available in a current registration area”, the UE 302 performs a PLMN selection or a SNPN selection for 3GPP access. The UE 302 performs a network selection for non-3GPP access. In some embodiments, the UE 302 performs the PLMN selection or the SNPN selection for 3GPP access according to 3GPP TS 23.122. The UE 302 performs the network selection for non-3GPP access according to 3GPP TS 24.502.

In some embodiments, the processor 310 receives a reject cause #62 (no network slices available) in a message from the network 304. In some embodiments, the reject message is either a REGISTRATION REJECT message or a DEREGISTRATION REQUEST message. The registration of the UE 302 is rejected with clause #62 (that is, no network slices available) in the message. The processor 310 has neither allowed network slice selection assistance information (NSSAI) for a current public land mobile network (PLMN) nor configured NSSAI for the current PLMN in the message. All single-NSSAI (S-NSSAI) in a default configured NSSAI are rejected, and at least one S-NSSAI is rejected due to “S-NSSAI not available in a current registration area”. Then, the processor 310 searches for a suitable cell in another tracking area. In some embodiments, the processor 310 searches for a suitable cell in another tracking area according to 3GPP TS 38.304 [28] or 3GPP TS 36.304 [25C].

In some embodiments, if the UE 302 has neither allowed NSSAI for a current PLMN nor configured NSSAI for the current PLMN in the message, all S-NSSAI in a default configured NSSAI are rejected, and at least one S-NSSAI is rejected due to “S-NSSAI not available in a current registration area”, the UE 302 does not search for a public land mobile network (PLMN). The UE 302 stays in the same tracking area identity (TAI) for a limited service. In some embodiments, the UE 302 enters a state of 5GMM-DEREGISTERED.LIMITED-SERVICE. In some embodiments, if the UE 302 has neither allowed NSSAI for a current PLMN nor configured NSSAI for the current PLMN in the message, all S-NSSAI in a default configured NSSAI are rejected, and at least one S-NSSAI is rejected due to “S-NSSAI not available in a current registration area”, the UE 302 searches for a suitable cell in the same PLMN but belonging to a tracking area which is not on the list of “5GS forbidden tracking areas for roaming”.

In some embodiments, the UE 302 has neither allowed NSSAI for a current PLMN nor configured NSSAI for the current PLMN in the message, all S-NSSAI in a default configured NSSAI are rejected, and at least one S-NSSAI is rejected due to “S-NSSAI not available in a current registration area”. If the UE 302 supports access to an SNPN using credentials from a credentials holder, equivalent SNPNs or both, a selected entry of a “list of subscriber data” or a selected same public land mobile network (PLMN) subscription, the UE 302 searches for a suitable cell in the same PLMN but belonging to a tracking area which is not on the list of “5GS forbidden tracking areas for roaming”.

In some embodiments, if the UE 302 has neither allowed NSSAI for a current PLMN nor configured NSSAI for the current PLMN in the message, all S-NSSAI in a default configured NSSAI are rejected, and at least one S-NSSAI is rejected due to “S-NSSAI not available in a current registration area”, the UE 302 performs a PLMN selection or a SNPN selection for 3GPP access. The UE 302 performs a network selection for non-3GPP access. In some embodiments, the UE 302 performs the PLMN selection or the SNPN selection for 3GPP access according to 3GPP TS 23.122. The UE 302 performs the network selection for non-3GPP access according to 3GPP TS 24.502.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method to recover from a forbidden tracking area identity (FTAI) after no slices available in a network, applied to user equipment (UE), comprising:
receiving a reject cause #62 (no network slices available) in a message from the network;
having an allowed network slice selection assistance information (NSSAI) or configured NSSAI in the message; wherein all single-NSSAI (S-NSSAI) in the allowed NSSAI and the configured NSSAI are rejected, and at least one S-NSSAI is rejected due to “S-NSSAI not available in a current registration area”, and
searching for a suitable cell in another tracking area.

2. The method as claimed in claim 1, wherein the message from the network is either a REGISTRATION REJECT message or a DEREGISTRATION REQUEST message.

3. The method as claimed in claim 1, further comprising:
not searching for a public land mobile network (PLMN); and
staying in the same tracking area identity (TAI) for a limited service.

4. The method as claimed in claim 1, further comprising:
searching for the suitable cell in the same public land mobile network (PLMN) but belonging to a tracking area which is not on a list of “5GS forbidden tracking areas for roaming”.

5. The method as claimed in claim 1, further comprising:
supporting access to a stand-alone non-Public network (SNPN) using credentials from a credentials holder, equivalent SNPNs or both, a selected entry of a “list of subscriber data” or a selected same public land mobile network (PLMN) subscription; and
searching for the suitable cell in the same PLMN but belonging to a tracking area which is not on a list of “5GS forbidden tracking areas for roaming”.

6. The method as claimed in claim 1, further comprising:
performing a public land mobile network (PLMN) selection or a stand-alone non-Public network (SNPN) selection for 3rd Generation Partnership Project (3GPP) access; and
performing a network selection for non-3GPP access.

7. The method as claimed in claim 3, further comprising:
entering a state of 5GMM-DEREGISTERED.LIMITED-SERVICE.

8. A method to recover from a forbidden tracking area identity (FTAI) after no slices available in a network, applied to user equipment (UE), comprising:
receiving a reject cause #62 (no network slices available) in a message from the network;
having neither allowed network slice selection assistance information (NSSAI) for a current public land mobile network (PLMN) nor configured NSSAI for the current PLMN in the message; wherein all single-NSSAI (S-NSSAI) in a default configured NSSAI are rejected, and at least one S-NSSAI is rejected due to “S-NSSAI not available in a current registration area”, and
searching for a suitable cell in another tracking area.

9. The method as claimed in claim 8, wherein the message from the network is either a REGISTRATION REJECT message or a DEREGISTRATION REQUEST message.

10. The method as claimed in claim 8, further comprising:
not searching for the PLMN; and
staying in the same tracking area identity (TAI) for a limited service.

11. The method as claimed in claim 8, further comprising:
searching for the suitable cell in the same PLMN but belonging to a tracking area which is not on a list of “5GS forbidden tracking areas for roaming”.

12. The method as claimed in claim 8, further comprising:
supporting access to a stand-alone non-Public network (SNPN) using credentials from a credentials holder, equivalent SNPNs or both, a selected entry of a “list of subscriber data” or a selected PLMN subscription; and
searching for the suitable cell in the same PLMN but belonging to a tracking area which is not on a list of “5GS forbidden tracking areas for roaming”.

13. The method as claimed in claim 8, further comprising:
performing a PLMN selection or a stand-alone non-Public network (SNPN) selection for 3rd Generation Partnership Project (3GPP) access; and
performing a network selection for non-3GPP access.

14. The method as claimed in claim 9, further comprising:
entering a state of 5GMM-DEREGISTERED.LIMITED-SERVICE.

15. An electronic device, comprising:
a processor, configured to:
receive a reject cause #62 (no network slices available) in a message from a network;
have an allowed network slice selection assistance information (NSSAI) or configured NSSAI in the message; wherein all single-NSSAI (S-NSSAI) in the allowed NSSAI and the configured NSSAI are rejected, and at least one S-NSSAI is rejected due to “S-NSSAI not available in a current registration area”, and
search for a suitable cell in another tracking area.

16. The electronic device as claimed in claim 14, wherein the message from the network is either a REGISTRATION REJECT message or a DEREGISTRATION REQUEST message.

17. The electronic device as claimed in claim 15, wherein the processor does not search for a public land mobile network (PLMN), and stays in the same tracking area identity (TAI) for a limited service.

18. The electronic device as claimed in claim 15, wherein the processor searches for the suitable cell in the same public land mobile network (PLMN) but belonging to a tracking area which is not on a list of “5GS forbidden tracking areas for roaming”.

19. The electronic device as claimed in claim 15, wherein the processor supports access to a stand-alone non-Public network (SNPN) using credentials from a credentials holder, equivalent SNPNs or both, a selected entry of a “list of subscriber data” or a selected same public land mobile network (PLMN) subscription, and searches for the suitable cell in the same PLMN but belonging to a tracking area which is not on a list of “5GS forbidden tracking areas for roaming”.

20. The electronic device as claimed in claim 15, wherein the processor performs a PLMN selection or a stand-alone non-Public network (SNPN) selection for 3rd Generation Partnership Project (3GPP) access, and performs a network selection for non-3GPP access.

21. The electronic device as claimed in claim 15, wherein the processor enters a state of 5GMM-DEREGISTERED.LIMITED-SERVICE.

22. An electronic device, comprising:
a processor, configured to:
receive a reject cause #62 (no network slices available) in a message from a network;
have neither allowed network slice selection assistance information (NSSAI) for a current public land mobile network (PLMN) nor configured NSSAI for the current PLMN in the message; wherein all single-NSSAI (S-NSSAI) in a default configured NSSAI are rejected, and at least one S-NSSAI is rejected due to “S-NSSAI not available in a current registration area”, and
search for a suitable cell in another tracking area.

23. The electronic device as claimed in claim 22, wherein the message from the network is either a REGISTRATION REJECT message or a DEREGISTRATION REQUEST message.

24. The electronic device as claimed in claim 22, wherein the processor does not search for a public land mobile network (PLMN), and stays in the same tracking area identity (TAI) for a limited service.

25. The electronic device as claimed in claim 22, wherein the processor searches for the suitable cell in the same public land mobile network (PLMN) but belonging to a tracking area which is not on a list of “5GS forbidden tracking areas for roaming”.

26. The electronic device as claimed in claim 22, wherein the processor supports access to a stand-alone non-Public network (SNPN) using credentials from a credentials holder, equivalent SNPNs or both, a selected entry of a “list of subscriber data” or a selected same public land mobile network (PLMN) subscription, and searches for the suitable cell in the same PLMN but belonging to a tracking area which is not on a list of “5GS forbidden tracking areas for roaming”.

27. The electronic device as claimed in claim 22, wherein the processor performs a PLMN selection or a stand-alone non-Public network (SNPN) selection for 3rd Generation Partnership Project (3GPP) access, and performs a network selection for non-3GPP access.
